(19) United States
(12) Patent Application Publication
(10) Pub. No.: US 2026/0145771 A1
(43) Pub. Date: May 28, 2026

(54) HYBRID AIRSHIP WITH DOWNWARD THRUST ROTORS

(71) Applicant: Float Air Inc., Dover, DE (US)

(72) Inventor: Ryan Kelly CONDRON, San Juan, PR (US)

(21) Appl. No.: 19/397,426

(22) Filed: Nov. 21, 2025

Related U.S. Application Data
(60) Provisional application No. 63/724,273, filed on Nov. 23, 2024.

(51) Int. Cl. B64B 1/30

(52) U.S. Cl. CPC B64B 1/30; B64B 2201/00

(57) ABSTRACT

A hybrid airship system comprising an envelope containing a lifting gas for generating buoyant lift, at least one rotor assembly mounted to the airship and configured to generate downward thrust to counteract over-buoyancy, and a control system configured to dynamically adjust operation of the at least one rotor assembly based on buoyancy conditions of the airship. The control system monitors buoyancy conditions and automatically activates the rotor assembly to generate downward thrust when over-buoyancy is detected, eliminating the need for ballast release. The rotor assembly operates in reverse thrust mode to provide precise altitude control and stability during flight operations. The lifting gas comprises helium or hydrogen contained within the envelope structure.

### CROSS-REFERENCE TO RELATED APPLICATIONS

This application claims priority to U.S. Provisional Application No. 63/724,273, titled Hybrid Airship System Utilizing Rotors for Downward Thrust and Over-Buoyancy Management, filed on Nov. 23, 2024, the disclosure of which is hereby incorporated by reference in its entirety.

### FIELD OF INVENTION

The present disclosure relates to hybrid aircraft systems, and more particularly to airships utilizing rotor systems.

### BACKGROUND

Airships have long been recognized as an efficient means of transportation due to their ability to generate lift through buoyant gases such as helium or hydrogen. Traditional airships rely primarily on the buoyant force of lighter-than-air gases contained within their envelopes to achieve and maintain flight. However, this reliance on static buoyancy creates operational challenges when the airship's lifting capacity exceeds the weight of its current payload.

When an airship carries cargo loads that are lighter than its maximum lifting capacity, the resulting over-buoyancy can lead to uncontrolled ascent, stability issues, and operational difficulties. Conventional airships address this problem through the use of ballast systems, which typically involve carrying and releasing expendable materials such as water or sand to balance the lift forces. This approach presents several drawbacks, including the waste of ballast materials, environmental concerns related to ballast release, and the added weight and complexity of ballast storage systems. Further, once ballast has been released, there is no mechanism for controlling further over buoyancy.

The integration of powered rotor systems in aircraft has been explored in various hybrid configurations. However, traditional applications of rotors in hybrid airships have been limited to forward propulsion or supplemental upward lift generation. The operational flexibility of such systems remains limited when dealing with excess buoyancy conditions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a hybrid airship system is provided. The hybrid airship system comprises an envelope containing a lifting gas for generating buoyant lift. The system comprises at least one rotor assembly mounted to the airship and configured to generate downward thrust to counteract over-buoyancy. The system comprises a control system configured to dynamically adjust operation of the at least one rotor assembly based on buoyancy conditions of the airship.

According to other aspects of the present disclosure, the hybrid airship system may include one or more of the following features. The lifting gas may comprise helium or hydrogen. The at least one rotor assembly may comprise a plurality of rotor assemblies positioned beneath the envelope. The plurality of rotor assemblies may be symmetrically positioned on either side of a longitudinal center-line of the airship. The control system may comprise sensors configured to monitor buoyancy conditions including lift forces, weight distribution, and altitude. The control system may be configured to automatically activate the at least one rotor assembly to generate downward thrust when over-buoyancy is detected. The control system may dynamically adjust rotor thrust levels in response to changes in environmental conditions and cargo weight.

According to another aspect of the present disclosure, a method for managing buoyancy in an airship is provided. The method comprises providing buoyant lift to an airship using a lifting gas contained within an envelope. The method comprises detecting an over-buoyancy condition of the airship. The method comprises generating downward thrust using at least one rotor to counteract the over-buoyancy condition.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a side view of a hybrid airship system with downward thrust rotors, according to aspects of the present disclosure.

FIG. 2 is a flowchart of a method of controlling buoyancy of an airship, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The hybrid airship system addresses challenges associated with over-buoyancy conditions that may occur during airship operations. Over-buoyancy may arise when an airship carries cargo loads that are lighter than the airship's maximum lifting capacity, creating operational difficulties such as uncontrolled ascent, stability issues, and reliance on ballast materials for weight management.

The hybrid airship system comprises an envelope containing a lifting gas for generating buoyant lift. The envelope may be constructed to contain helium or hydrogen gas, which provides the primary lifting force for the airship. The lifting gas within the envelope creates buoyant lift that enables the airship to achieve flight and carry cargo loads.

The system further comprises at least one rotor assembly mounted to the airship and configured to generate downward thrust to counteract over-buoyancy, i.e., to substantially oppose the buoyant forces of the airship. The rotor assembly may be positioned beneath the envelope and may operate in a reverse thrust mode to produce downward force. The downward thrust generated by the rotor assembly provides a mechanism for actively managing excess buoyancy without requiring the release of ballast materials. In some instances, the downward thrust is in direct opposition to the buoyancy force of the airship.

A control system may be configured to dynamically adjust operation of the at least one rotor assembly based on buoyancy conditions of the airship. The control system may monitor various parameters related to the airship's buoyancy state and automatically activate or adjust the rotor assembly to maintain desired altitude and stability. The control system may respond to changes in cargo weight, environmental conditions, and other factors that affect the airship's buoyancy characteristics.

The integration of these components provides a solution for managing over-buoyancy through active thrust control rather than passive ballast systems. The rotor assembly may transition between different operational modes, including lift generation, idle operation, and downward thrust generation, depending on the buoyancy management requirements determined by the control system.

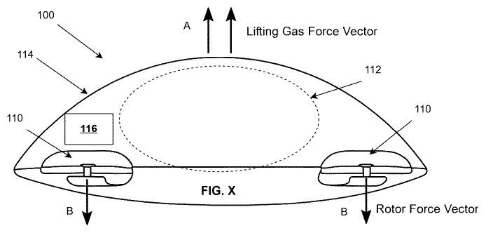

Referring to FIG. 1, a hybrid airship system 100 may include an envelope structure 112 and a rigid body 114 that exhibits a streamlined aerodynamic profile with a curved upper surface and a flatter lower surface. In this example, the envelope structure 112 and the rigid body 114 are separate elements. However, the envelope structure 112 and the rigid body 114 can be one integral element that provides some level of structural rigidly to the airship and contains the buoyant gas. The envelope 112 may contain a lifting gas composition that comprises, for example, helium or hydrogen. Helium may provide a safer lifting gas option due to its non-flammable properties, while hydrogen may offer greater lifting capacity per unit volume. The lifting gas within the envelope generates the primary buoyant lift forces that enable the airship to achieve flight operations.

At least one rotor assembly 110 can be mounted on the rigid body 114. As shown in FIG. 1, a plurality of rotor assemblies 110 may be symmetrically positioned on either side of a longitudinal and/or latitudinal center-line of the airship. Each rotor assembly 110 may include a housing with a rotor mechanism contained within the housing structure. The rotor mechanism can include a rotor and a mechanism for providing motive force to the rotor. The rotor assemblies may be mounted on or integrated into the airship structure, providing flexibility in the mechanical attachment configuration.

The rotor assemblies 110 may operate in multiple operational modes including upward thrust, idle, and downward thrust modes. The rotors may transition dynamically between these operational states based on the buoyancy management requirements. When generating downward thrust, the method may comprise operating the at least one of the rotor assemblies 110 in a reverse thrust mode, as illustrated by the downward-pointing rotor force vectors B in FIG. 1. The reverse thrust mode produces downward force that counteracts excess buoyancy force (vector A) from the lifting gas. The rotor assemblies 110 can be operated independently from on another or in concert with one another. The mechanism for providing motive force to the rotors may be an electric or hybrid propulsion system. A hybrid propulsion system may combine electric motors with conventional engines to extend operational range and provide backup power capabilities for extended flight operations.

A control system 116 may include a preprogrammed or programmable microprocessor and sensors configured to monitor buoyancy conditions including lift forces, weight distribution, and altitude. The sensors may also monitor wind conditions and flight dynamics to provide comprehensive environmental awareness. The control system may be configured to automatically activate the at least one rotor assembly to generate downward thrust when over-buoyancy is detected through sensor feedback.

The control system 116 may dynamically adjust rotor thrust levels in response to changes in environmental conditions and cargo weight. The dynamic adjustment capability allows the system to respond to varying operational parameters without manual intervention. The control system may minimize energy use by dynamically balancing buoyant lift with rotor thrust for energy optimization, reducing overall power consumption during flight operations.

The system may include regenerative energy recovery capability through integration of regenerative braking during descent operations. The regenerative system may store energy for future use by converting the kinetic energy of descending motion into electrical energy that charges onboard batteries or power storage systems. The energy recovery capability may improve overall system efficiency during operational cycles.

The hybrid airship system may be designed for heavy-lift applications with cargo capacities in the range of tens of thousands of pounds. The heavy-lift design may accommodate substantial payload variations while maintaining stability through active rotor control. The system may enable operation in remote locations without requiring ground-based anchoring infrastructure, as the downward thrust capability provides stability during landing and ground operations in areas lacking specialized support equipment.

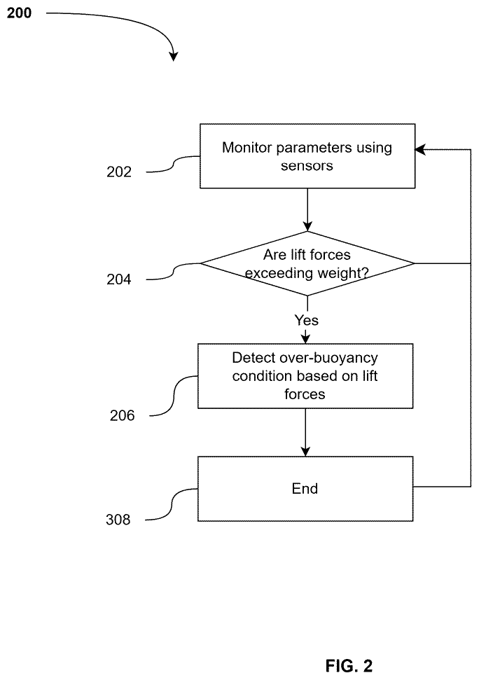

An example of a method 200 for managing buoyancy in an airship is illustrated in FIG. 2. As the lifting gas generates buoyant forces that enable the airship to achieve flight and carry cargo loads, flight parameters are detected by the sensors and monitored by the control system in step 202. When it is detected that lifting forces undesirably exceed weight, at step 204, and over-buoyancy condition is determined as step 206. At step 208, the controller can activate/adjust one or more of the rotor assemblies to counter the over-buoyancy condition.

Detecting the over-buoyancy condition may comprise monitoring at least one parameter selected from lift forces, weight distribution, altitude, and environmental conditions using sensors. The sensors may measure lift forces generated by the lifting gas and compare these forces to the total weight of the airship and cargo load. Weight distribution monitoring may track changes in cargo positioning and mass distribution throughout the airship structure.

Altitude monitoring may detect uncontrolled ascent patterns that indicate excess buoyancy relative to the desired flight profile. Environmental condition monitoring may include wind speed, atmospheric pressure, and temperature measurements that affect buoyancy characteristics. The combination of these monitored parameters may provide comprehensive data for determining when over-buoyancy conditions exist.

The sensors may provide real-time feedback to the control system that automatically activates the at least one rotor when the over-buoyancy condition is detected. The real-time feedback capability may enable rapid response to changing buoyancy conditions without manual intervention. The control system may process sensor data continuously and compare measured parameters against predetermined thresholds to identify over-buoyancy situations.

The method may comprise generating downward thrust using at least one rotor to counteract the over-buoyancy condition. The downward thrust generation may occur through rotor operation in a reverse thrust configuration that produces force vectors directed toward the ground. The magnitude of downward thrust may be calculated based on the degree of over-buoyancy detected through the sensor monitoring system.

The control system may dynamically adjust a thrust level of the at least one rotor in response to changes in the monitored parameters. Dynamic thrust adjustment may occur continuously during flight operations as environmental conditions and cargo configurations change. The thrust level adjustments may maintain altitude stability and prevent uncontrolled ascent while minimizing energy consumption through optimized rotor operation.

The method may further comprise a step of eliminating ballast release by using the downward thrust to counteract the over-buoyancy condition. The elimination of ballast release may reduce operational costs and environmental impact associated with traditional ballast systems. The downward thrust may provide equivalent buoyancy management functionality without requiring the jettisoning of ballast materials such as water or sand.

The integrated system components may interact to perform coordinated buoyancy management functions throughout flight operations. The lifting gas within the envelope may provide baseline buoyant lift while the rotor assemblies may supplement or counteract this lift based on operational requirements. The control system may coordinate these components by processing sensor feedback and adjusting rotor operations to maintain desired flight characteristics.

The operational flexibility enabled by this integrated approach may allow the airship to adapt to varying cargo weights and environmental conditions without requiring manual adjustments or external support systems. The system may respond to cargo loading changes, fuel consumption variations, and atmospheric condition fluctuations through automatic rotor thrust adjustments. This flexibility may enable operations in diverse environments including remote areas without specialized ground support infrastructure.

During flight operations, the system may continuously balance buoyant lift forces with rotor-generated thrust to maintain stable altitude and position control. The balance may be achieved through algorithmic control that optimizes energy efficiency while maintaining operational safety margins. The system may transition between different operational modes based on flight phase requirements, including takeoff, cruise, descent, and landing operations.

The rotor assemblies 110 may comprise various rotor configurations suitable for generating the required thrust forces. The rotors may include axial flow rotors, centrifugal rotors, mixed-flow rotors, and radial rotors, each offering different operational characteristics for buoyancy management applications.

Axial flow rotors may be configured such that airflow moves parallel to the rotor axis, providing efficient thrust generation with relatively low power consumption. These rotors may be particularly suitable for applications requiring sustained downward thrust over extended periods. The axial flow design may enable smooth airflow patterns that minimize turbulence and noise during operation.

Centrifugal rotors may direct airflow perpendicular to the rotor axis through centrifugal force, creating high-pressure differentials that generate substantial thrust forces. These rotors may be advantageous for applications requiring rapid thrust changes or high-magnitude downward forces to counteract significant over-buoyancy conditions. The centrifugal design may provide compact rotor assemblies with high thrust-to-weight ratios.

Mixed-flow rotors may combine characteristics of both axial and centrifugal designs, allowing airflow to move at an angle to the rotor axis. This configuration may offer operational flexibility by providing variable thrust characteristics that can be optimized for different flight conditions. Mixed-flow rotors may enable efficient operation across a range of thrust requirements while maintaining acceptable noise levels.

Radial rotors may feature blades extending radially from a central hub, creating airflow patterns that move outward from the rotor center. These rotors may provide uniform thrust distribution and may be particularly suitable for applications requiring precise altitude control. The radial design may offer enhanced stability characteristics during variable wind conditions.

The rotor assemblies may also incorporate variable-pitch rotor blades that allow dynamic adjustment of blade angles to optimize thrust generation for different operational requirements. Variable-pitch systems may enable the rotors to transition efficiently between upward thrust, idle, and downward thrust modes without requiring changes in rotor rotation direction. The blade pitch adjustment capability may provide fine-tuned control over thrust magnitude and direction.

Ducted rotor configurations may be employed to enhance thrust efficiency and reduce noise generation during operation. The ducted design may improve airflow characteristics and provide additional safety benefits by containing the rotor blades within a protective housing. Ducted rotors may also offer improved performance in crosswind conditions by reducing the effects of external airflow disturbances. Further the rotors can include jet turbines of the like. Accordingly, the term “rotor”, as used herein, includes any mechanism for providing thrust.

Landing operations may benefit from the downward thrust capability through enhanced stability control during descent phases. The downward thrust may counteract buoyant lift to enable controlled descent rates even in variable wind conditions. The landing process may be accomplished without requiring anchor teams or specialized ground infrastructure, as the rotor system may provide sufficient downward force to maintain ground contact and stability.

A number of implementations have been described. Nevertheless, it will be understood that various modifications may be made without departing from the spirit and scope of the disclosure. Accordingly, other implementations are within the scope of the following claims.

1. A hybrid airship system, comprising:
an envelope containing a lifting gas for generating buoyant lift;
at least one rotor assembly mounted to the airship and configured to generate downward thrust to counteract over-buoyancy; and
a control system configured to dynamically adjust operation of the at least one rotor assembly based on buoyancy conditions of the airship.

2. The hybrid airship system of claim 1, wherein the lifting gas comprises helium or hydrogen.

3. The hybrid airship system of claim 1, wherein the at least one rotor assembly comprises a plurality of rotor assemblies positioned beneath the envelope.

4. The hybrid airship system of claim 3, wherein the plurality of rotor assemblies are symmetrically positioned on either side of a longitudinal centerline of the airship.

5. The hybrid airship system of claim 1, wherein the control system comprises sensors configured to monitor buoyancy conditions including lift forces, weight distribution, and altitude.

6. The hybrid airship system of claim 5, wherein the control system is configured to automatically activate the at least one rotor assembly to generate downward thrust when over-buoyancy is detected.

7. The hybrid airship system of claim 6, wherein the control system dynamically adjusts rotor thrust levels in response to changes in environmental conditions and cargo weight.

8. A method for managing buoyancy in an airship, comprising:
providing buoyant lift to an airship using a lifting gas contained within an envelope;
detecting an over-buoyancy condition of the airship; and
generating downward thrust using at least one rotor to counteract the over-buoyancy condition.

9. The method of claim 8, wherein detecting the over-buoyancy condition comprises monitoring at least one parameter selected from lift forces, weight distribution, altitude, and environmental conditions using sensors.

10. The method of claim 9, wherein the sensors provide real-time feedback to a control system that automatically activates the at least one rotor when the over-buoyancy condition is detected.

11. The method of claim 10, wherein the control system dynamically adjusts a thrust level of the at least one rotor in response to changes in the monitored parameters.

12. The method of claim 8, wherein generating downward thrust comprises operating the at least one rotor in a reverse thrust mode.

13. The method of claim 8, further comprising a step of eliminating ballast release by using the downward thrust to counteract the over-buoyancy condition.

14. The method of claim 8, wherein the lifting gas comprises helium or hydrogen.
